(19) United States
(12) Patent Application Publication
(10) Pub. No.: US 2026/0023303 A1
(43) Pub. Date: Jan. 22, 2026

(54) CAMERA MODULE AND CAMERA MODULE ASSEMBLY INCLUDING THE SAME

(71) Applicant: SAMSUNG ELECTRONICS CO., LTD., Suwon-si (KR)

(72) Inventors: Minook KIM, Suwon-si (KR); Seung Hak Lee, Suwon-si (KR); Dongjoon Won, Suwon-si (KR); Kyungsung Chu, Suwon-si (KR)

(73) Assignee: SAMSUNG ELECTRONICS CO., LTD., Suwon-si (KR)

(21) Appl. No.: 19/048,225

(22) Filed: Feb. 7, 2025

(30) Foreign Application Priority Data
Jul. 19, 2024 (KR) 10-2024-0095787

(51) Int. Cl. G03B 13/36; G03B 30/00

(52) U.S. Cl. CPC G03B 13/36; G03B 30/00

(57) ABSTRACT

Provided is a camera module including a housing, and a coupling frame on the housing, wherein the housing includes a first main surface, and a first side surface and a second side surface connected to the first main surface and spaced apart in a first direction, and wherein the coupling frame includes a second main surface, a third side surface and a fourth side surface connected to the second main surface and spaced apart in the first direction, a first coil on the second main surface, a second coil on the third side surface, and a third coil on the fourth side surface.

### CROSS-REFERENCE TO RELATED APPLICATION

This application claims priority to Korean Patent Application No.10-2024-0095787 filed on Jul. 19, 2024, in the Korean Intellectual Property Office, the disclosure of which is incorporated by reference herein in its entirety.

### BACKGROUND

Embodiments of the present disclosure relate to a camera module and a camera module assembly including the same, and more specifically, relate to a camera module with reduced lens position dispersion and a camera module assembly including the same.

With the development of electronic devices, various electronic devices have been applied to various fields closely related to lives of a user of the electronic devices. These electronic devices have been released in various sizes depending on functions and user preferences. For example, the electronic device may include a large-screen touch display for securing wide visibility and convenience of operation. The electronic device may include at least one camera module. For example, the electronic device may include at least one camera module disposed around or through a display.

### SUMMARY

One or more embodiments provide a camera module with reduced lens position dispersion and a camera module assembly including the same.

According to an aspect of one or more embodiments, there is provided a camera module including a housing, and a coupling frame on the housing, wherein the housing includes a first main surface, and a first side surface and a second side surface connected to the first main surface and spaced apart in a first direction, and wherein the coupling frame includes a second main surface, a third side surface and a fourth side surface connected to the second main surface and spaced apart in the first direction, a first coil on the second main surface, a second coil on the third side surface, and a third coil on the fourth side surface.

According to another aspect of one or more embodiments, there is provided a camera module including a housing, an autofocus (AF) carrier configured to move in a first direction in the housing, a lens carrier configured to move in the first direction and a second direction perpendicular to the first direction on the AF carrier, and a coupling frame on the housing, wherein the AF carrier includes a first magnet on a first surface of the AF carrier, wherein the lens carrier includes a second magnet on a first side surface of the lens carrier, and a third magnet on a second side surface of the lens carrier opposite to the first side surface of the lens carrier, wherein the coupling frame includes a first coil, a second coil, and a third coil spaced apart from each other, wherein the first magnet overlaps the first coil in a third direction perpendicular to the first direction and the second direction, wherein the second magnet faces the second coil, and wherein the third magnet faces the third coil.

According to still another aspect of one or more embodiments, there is provided a camera assembly module including a housing, an autofocus (AF) carrier on a first surface of the housing, a lens carrier on the AF carrier, a telephoto lens on the lens carrier, a middle guide between the AF carrier and the lens carrier, a coupling frame and a connection substrate on the housing, and an image sensor on the connection substrate, wherein the housing includes a first main surface, and a first side surface, a second side surface, and a third side surface connected to the first main surface, wherein the coupling frame includes a second main surface, a fourth side surface and a fifth side surface connected to the second main surface, the fourth side surface and the fifth side surface being spaced apart in a first direction, a first coil on the second main surface, a second coil on the fourth side surface, and a third coil on the fifth side surface, wherein an angle formed by the second main surface and the fourth side surface and an angle formed by the second main surface and the fifth side surface are 90 degrees, and wherein the middle guide is configured to move the lens carrier in a second direction perpendicular to the first direction.

### BRIEF DESCRIPTION OF DRAWINGS

The above and other aspects and features of the present disclosure will become more apparent by describing in detail exemplary embodiments thereof with reference to the attached drawings, in which:

FIG. 1 is a perspective view illustrating a camera module assembly according to one or more embodiments;

FIG. 2 is a cross-sectional view of the camera module assembly shown in FIG. 1;

FIG. 3 is a cross-sectional view of the camera module assembly shown in FIG. 1;

FIG. 4 is a perspective view illustrating a portion of a camera module assembly according to one or more embodiments;

FIG. 5 is a perspective view illustrating a housing and a coupling frame according to one or more embodiments;

FIG. 6 is a perspective view illustrating a housing according to one or more embodiments;

FIG. 7 is a perspective view illustrating a coupling frame according to one or more embodiments;

FIG. 8 is a perspective view illustrating an autofocus (AF) carrier and a reflective holder according to one or more embodiments;

FIG. 9 is a perspective view illustrating an AF carrier, a reflective holder, and a middle guide according to one or more embodiments;

FIGS. 10A and 10B are perspective views illustrating a lens carrier and an image sensor according to one or more embodiments;

FIG. 10C is a bottom view illustrating a lens carrier and an image sensor according to one or more embodiments; and

FIG. 11 is a flowchart for measuring a calibration value of a camera module according to one or more embodiments.

### DETAILED DESCRIPTION

Hereinafter, embodiments will be described in detail with reference to the attached drawings. Embodiments described herein are example embodiments, and thus, the disclosure is not limited thereto.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

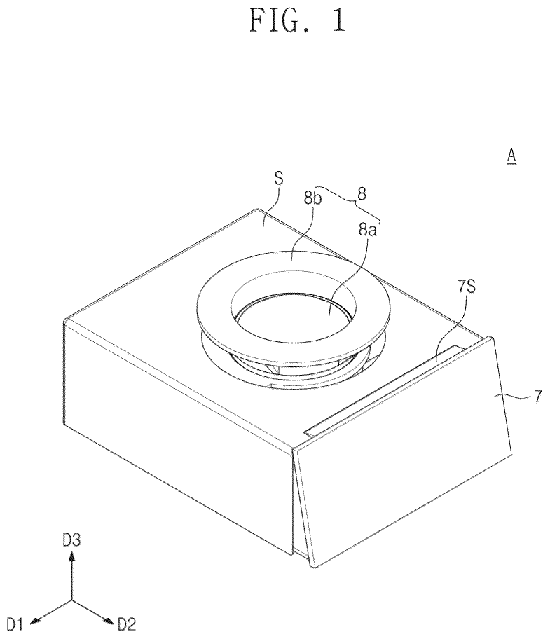

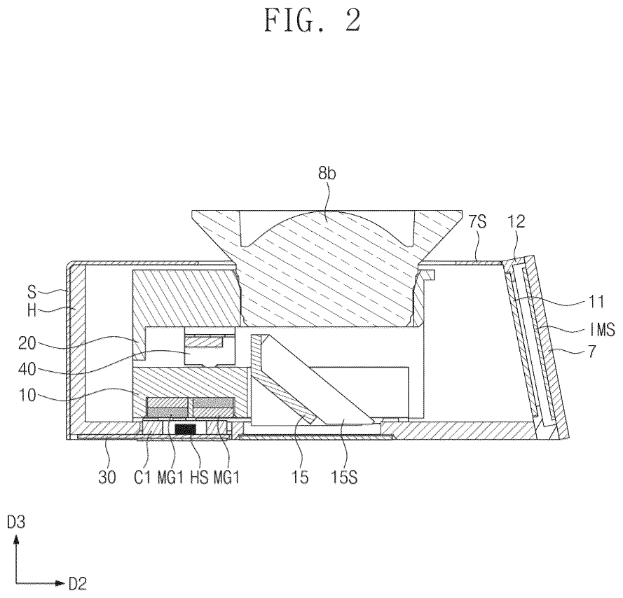

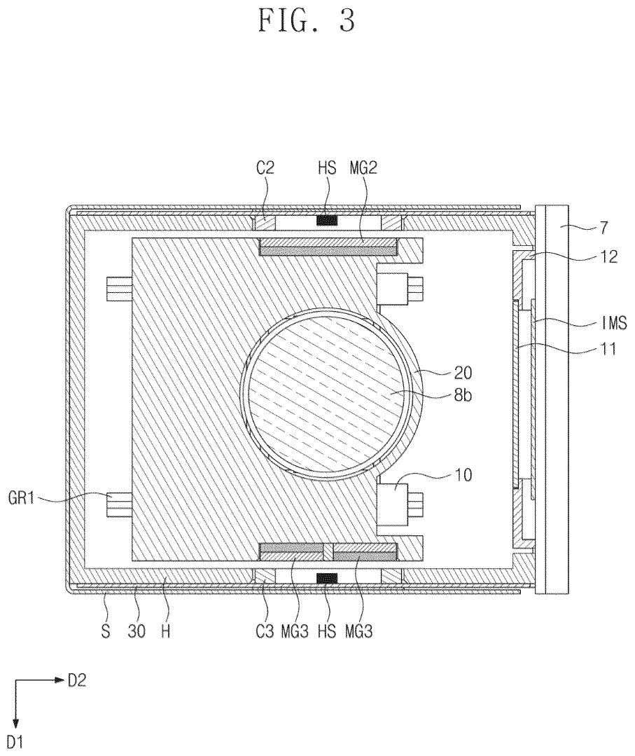

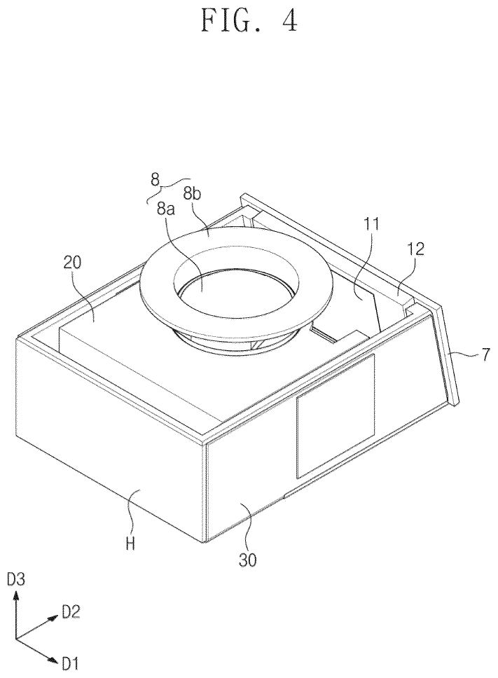

FIG. 1 is a perspective view illustrating a camera module assembly according to one or more embodiments. FIG. 2 is a cross-sectional view of the camera module assembly shown in FIG. 1. FIG. 3 is a cross-sectional view of the camera module assembly shown in FIG. 1. FIG. 4 is a perspective view illustrating a portion of a camera module assembly according to one or more embodiments. FIG. 4 is a perspective view illustrating remaining components except for a shield can S in FIG. 1.

In the present disclosure, D1 may be referred to as a first direction, D2 intersecting the first direction D1 may be referred to as a second direction D2, and D3 intersecting each of the first direction D1 and the second direction D2 may be referred to as a third direction D3. Each of the first direction D1 and the second direction D2 may be referred to as a horizontal direction. The third direction D3 may be referred to as a vertical direction. The first direction D1 and the second direction D2 may be, for example, approximately perpendicular to each other. The first direction D1 and the third direction D3 may be, for example, approximately perpendicular to each other. The second direction D2 and the third direction D3 may be, for example, approximately perpendicular to each other.

Referring to FIGS. 1 to 4, a camera module assembly A may be provided. The camera module assembly A may receive light from the outside surface and generate an electrical signal. To this end, the camera module assembly A may include a camera module and an image sensor IMS. The camera module may be the remaining components of the camera module assembly A excluding the image sensor IMS. The image sensor IMS may be combined with and connected to the camera module. The image sensor IMS may convert an optical signal received by the camera module into an electrical signal.

The camera module assembly A may be included in an electronic device. For example, the camera module assembly A may be included in a smart phone and/or a pad, etc. To this end, the camera module assembly A may include a shield can S, a connection substrate 7, a housing H, an image sensor IMS, an AF carrier 10, a lens carrier 20, a telephoto lens assembly 8, and a coupling frame 30.

The shield can S and the connection substrate 7 may be combined with and connected to each other. The connection substrate 7 may be combined with and connected to one side surface of the shield can S through a connection member 7S located on an upper surface of the shield can S. The shield can S may protect the camera module assembly A from external impact. The shield can S may include a metal material. The connection substrate 7 may be a printed circuit board (PCB).

The image sensor IMS may be provided on the connection substrate 7. The image sensor IMS may be, for example, a charge coupled device (CCD) or a CMOS image sensor (CIS).

An infrared cut filter (IRCF) 11 may be provided on the connection substrate 7. According to one or more embodiments, an air gap may be between the IRCF 11 and the image sensor IMS. The IRCF 11 may filter infrared rays entering the image sensor IMS.

A filter base 12 may be combined with and connected to the connection substrate 7 and the IRCF 11. For example, the filter base 12 may fix the IRCF 11 on the connection substrate 7.

The housing H and the coupling frame 30 fixed to the housing H may be provided in the shield can S. The housing H may include a first groove GR1 on a bottom surface of the housing H. The coupling frame 30 may include a first coil C1, a second coil C2, a third coil C3 arranged to be spaced apart from each other, and hall sensors CS positioned in the first to third coils C1 to C3. Details of the housing H and the coupling frame 30 will be described later.

The AF carrier 10 may be combined with and connected to the housing H. The AF carrier 10 may include a first magnet MG1 on a lower surface of the AF carrier 10. The first magnet MG1 and the first coil C1 may overlap each other in the third direction D3. For example, the first magnet MG1 of the AF carrier 10 may be positioned above the first coil C1 of the coupling frame 30 in the third direction D3. The first magnet MG1 may be provided in the plural and include a plurality of first magnets MG1. For example, the first magnet MG1 may include two magnets positioned adjacent to each other in the second direction D2.

A reflective holder 15 may be combined with and connected to the AF carrier 10. For example, the reflective holder 15 may be supported by the AF carrier 10. A reflective member 15S may be combined with and connected to the reflective holder 15. The reflective member 15S may include, for example, a mirror or a prism.

A middle guide 40 may be provided on the AF carrier 10. The middle guide 40 may be combined with and connected to the AF carrier 10. The lens carrier 20 may be provided on the middle guide 40. For example, the middle guide 40 may be located between the AF carrier 10 and the lens carrier 20. The middle guide 40 may be combined with and connected to the lens carrier 20. Accordingly, the lens carrier 20 may move through the middle guide 40. A detailed description thereof will be described later.

The lens carrier 20 may include a second magnet MG2 on one side surface and a third magnet MG3 on the other side surface opposite to the one side surface. The second magnet MG2 may face the second coil C2 of the coupling frame 30. The third magnet MG3 may face the third coil C3 of the coupling frame 30. The lens carrier 20 may operate as an optical image stabilization (OIS).

The telephoto lens assembly 8 may be combined with and connected to the lens carrier 20. The telephoto lens assembly 8 may include a telephoto lens 8a and a lens housing 8b. The lens housing 8b may support the telephoto lens 8a. That is, the telephoto lens 8a may be placed in the lens housing 8b. External light may pass through the telephoto lens 8a in the third direction D3 and reach the reflective member 15S. Then, the reflective member 15S may reflect the light passing through the telephoto lens 8a to the image sensor IMS. The telephoto lens 8a may include a convex lens and/or a concave lens. The telephoto lens 8a may adjust the focus through the AF carrier 10.

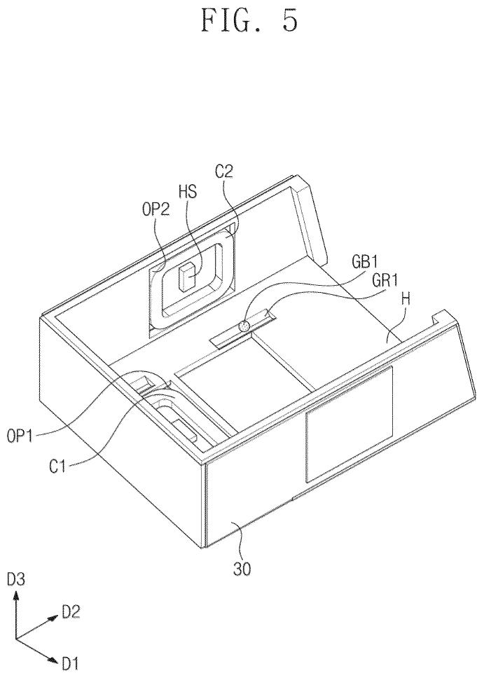

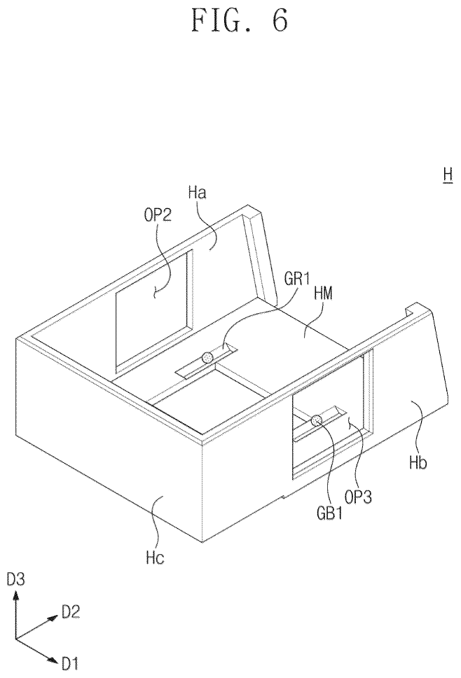

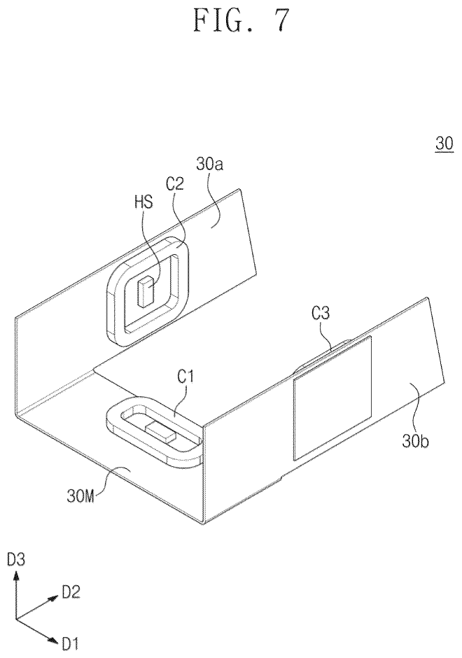

FIG. 5 is a perspective view illustrating a housing and a coupling frame according to one or more embodiments. FIG. 6 is a perspective view illustrating a housing according to one or more embodiments. FIG. 7 is a perspective view illustrating a coupling frame according to one or more embodiments.

Referring to FIGS. 5 to 7, a coupling frame 30 may be provided fixed to a housing H. For example, as shown in FIG. 6, the housing H according to one or more embodiments may include a first main surface HM, and a first side surface Ha, a second side surface Hb, and a third side surface Hc that are connected to the first main surface HM. The first main surface HM may correspond to a bottom surface of the housing H. The first side surface Ha and the second side surface Hb may be connected to both side surfaces of the first main surface Ha, respectively. The first side surface Ha and the second side surface Hb may be spaced apart in the first direction D1. The first side surface Ha and the second side surface Hb may face each other. The third side surface Hc may connect the first side surface Ha and the second side surface Hb.

As shown in FIGS. 5 and 6, the first main surface HM, the first side surface Ha, and the second side surface Hb may include a first opening OP1, a second opening OP2, and a third opening OP3, respectively. A shape of the first to third openings OP1 to OP3 are not limited to those illustrated and may be variously changed.

A plurality of first grooves GR1 may be disposed on the first main surface HM. The first grooves GR1 may be spaced apart from each other in the first direction D1 and the second direction D2. Each of the first grooves GR1 may extend in the second direction D2. A cross section of the first groove GR1 may have a ‘V’ shape.

First guide balls GB1 may be provided on each of the first grooves GR1. Each of the first guide balls GB1 of the housing H may be provided in a groove formed in the first main surface MA to move the AF carrier 10 to be described later in the first direction D1.

Referring again to FIGS. 2 to 7, the coupling frame 30 according to the one or more embodiments may include a second main surface 30M and a fourth side surface 30a and a fifth side surface 30b connected to the second main surface 30M. The second main surface 30M may correspond to a bottom surface of the coupling frame 30. The fourth side surface 30a and the fifth side surface 30b may be connected to the two side surfaces of the second main surface 30M, respectively. The fourth side surface 30a and the fifth side surface 30b may be spaced apart in the first direction D1. The fourth side surface 30a and the fifth side surface 30b may face each other. The second main surface 30M may connect the fourth side surface 30a and the fifth side surface 30b.

For example, the second main surface 30M may combine a portion of a corner of the fourth side surface 30a and a portion of a corner of the fifth side surface 30b. An angle formed by the second main surface 30M and the fourth side surface 30a and an angle formed by the second main surface 30M and the fifth side surface 30b may be 90 degrees.

The first coil C1 may be provided on the second main surface 30M. The second coil C2 may be provided on the fourth side surface 30a. The third coil C3 may be provided on the fifth side surface 30b. For example, the first coil C1 may be located between the second coil C2 and the third coil C3.

When power is applied to the first coil C1, the first magnet MG1 on a lower surface of the AF carrier 10 may move relative to the first coil C1 in the second direction D2. When power is applied to the second coil C2, the second magnet MG2 of the lens carrier 20 may move relative to the second coil C2 in the first direction D1. When power is applied to the third coil C3, the third magnet MG3 of the lens carrier 20 may move relative to the third coil C3 in the second direction D2. For example, each of the first to third coils C1 to C3 may form an actuator with the first to third magnets MG1 to MG3 described above, and the actuator may be a voice coil motor (VCM).

Referring again to FIGS. 2 to 7, the coupling frame 30 may be combined with and connected to the housing H to surround a portion of the exterior of the housing H. For example, the second main surface 30M may be positioned below the first main surface HM in the third direction D3. The fourth side surface 30a may be positioned on the first side surface Ha. The fifth side surface 30b may be positioned on the second side surface Hb. For example, the coupling frame 30 may surround the remaining surfaces of the housing H except for the third side surface Hc. In this case, each of the first to third coils C1 to C3 on the coupling frame 30 may be positioned in the first to third openings OP1 to OP3 of the housing H.

The hall sensors HS may be positioned in the first to third coils C1 to C3. The hall sensors HS may measure a magnetic field value changed as the first to third magnets MG1 to MG3 move.

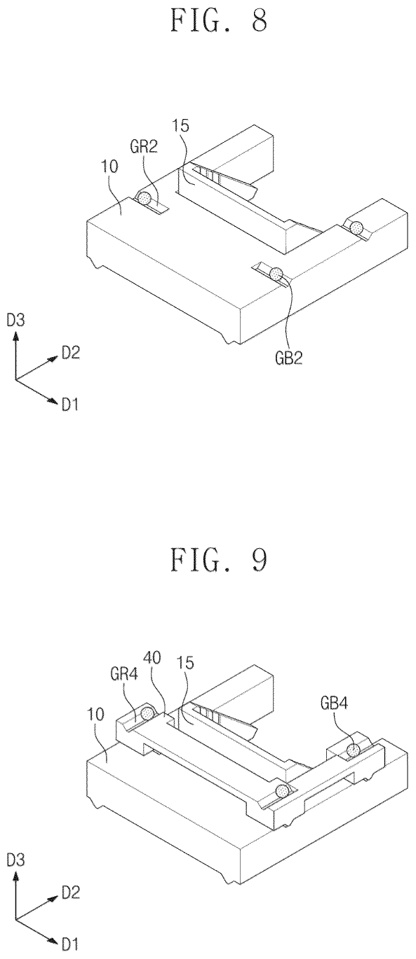

FIG. 8 is a perspective view illustrating an AF carrier and a reflective holder according to one or more embodiments.

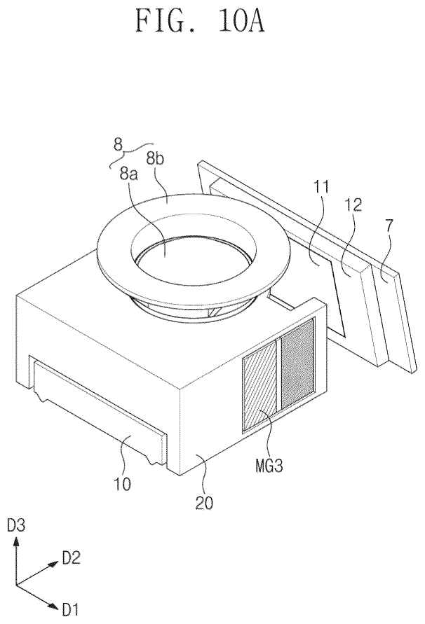

Referring to FIGS. 2 to 8, the AF carrier 10 may be combined with and connected to the housing H. A plurality of second grooves GR2 may be disposed on an upper surface of the AF carrier 10. A plurality of third grooves GR3 may be disposed on a lower surface of the AF carrier 10. A second guide ball GB2 and a third guide ball may be provided on the second groove GR2 and the third groove GR3, respectively. A description of the third groove GR3 and the third guide ball will be described later in FIG. 9C.

The second grooves GR2 may be spaced apart from each other in the first direction D1 and the second direction D2. Each of the second grooves GR2 may extend in the first direction D1. A cross section of the second groove GR2 may have a ‘V’ shape. The second groove GR2 may correspond to a groove formed on the upper surface of the AF carrier 10.

The second guide balls GB2 may be provided on the second grooves GR2, respectively. For example, each of the second guide balls GB2 may be provided in a groove formed on the upper surface of the AF carrier 10 to move the middle guide 40 described below and the lens carrier 20 combined with and connected to the middle guide 40 in the first direction D1.

The reflective holder 15 may be combined with and connected to the AF carrier 10. For example, the reflective holder 15 may be supported by the AF carrier 10.

FIG. 9 is a perspective view illustrating an AF carrier, a reflective holder, and a middle guide according to one or more embodiments.

Referring to FIGS. 8 and 9, the middle guide 40 may be provided on the AF carrier 10. For example, the middle guide 40 may be combined with and connected to the AF carrier 10 through the second groove GR2 and the second guide ball GB2 located on the upper surface of the AF carrier 10. In this case, as the second groove GR2 of the AF carrier 10 extends in the first direction D1, the middle guide 40 may move in the same first direction D1 as the direction in which the second groove GR2 extends.

A plurality of fourth grooves GR4 may be disposed on an upper surface of the middle guide 40. The fourth grooves GR4 may be spaced apart from each other in the first direction D1 and the second direction D2. Each of the fourth grooves GR4 may extend in the second direction D2. A cross section of the fourth groove GR4 may have a ‘V’ shape. The fourth groove GR4 may correspond to a groove formed on the upper surface of the middle guide 40.

Fourth guide balls GB4 may be provided on the fourth grooves GR4, respectively. Each of the fourth guide balls GB4 may be provided in a groove formed on the upper surface of the middle guide 40 to move the lens carrier 20 described below in the second direction D2.

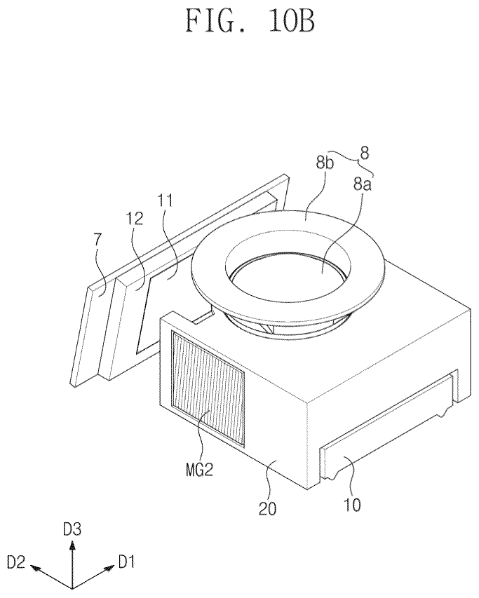

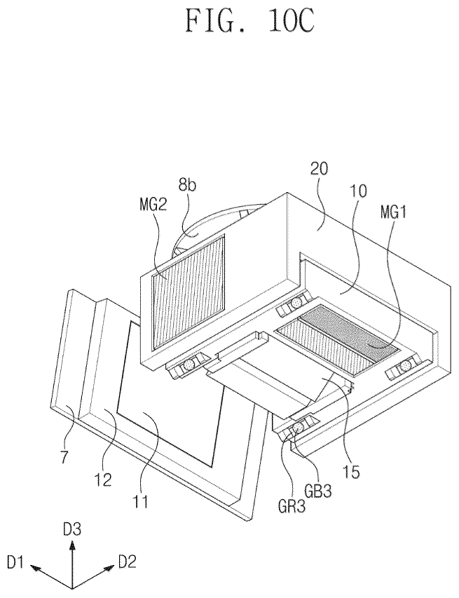

FIGS. 10A and10B are perspective views illustrating a lens carrier and an image sensor according to one or more embodiments. FIG. 10C is a bottom view illustrating a lens carrier and an image sensor according to one or more embodiments.

Referring to FIGS. 9 to 10C, the lens carrier 20 may be provided on the middle guide 40. The lens carrier 20 may be combined with and connected to the middle guide 40 through the fourth groove GR4 and the fourth guide ball GB4. The lens carrier 20 may be spaced apart from the connection substrate 7 and the IRCF 11 in the second direction D2. In this case, as described above, since the middle guide 40 moves in the first direction D1 through the second groove GR2 and the second guide ball GB2 on the upper surface of the AF carrier 10, the lens carrier 20 combined with and connected to the middle guide 40 may also move in the first direction D1.

The lens carrier 20 may include the second magnet MG2 on one side surface and the third magnet MG3 on the other side surface opposite to the one side surface. The second magnet MG2 and the third magnet MG3 may be spaced apart in the first direction D1. The third magnet MG3 may be provided in the plural and include a plurality of third magnets MG3. For example, the third magnet MG3 may include two magnets that are positioned adjacent to each other in the second direction D2.

Referring to FIG. 6 and FIG. 10C, a plurality of third grooves GR3 may be disposed on the lower surface of the AF carrier 10. The third grooves GR3 may be spaced apart from each other in the first direction D1 and the second direction D2. Each of the third grooves GR3 may extend in the second direction D2. A cross section of the third groove GR3 may have a ‘V’ shape. The third groove GR3 may correspond to a groove formed on the lower surface of the AF carrier 10.

The third guide balls GB3 may be provided on the third grooves GR3, respectively. Each of the third guide balls GB3 may be provided in a groove formed on the lower surface of the AF carrier 10.

In this case, the housing H and the AF carrier 10 may be combined with and connected to each other through the first guide ball GB1 on the first groove GR1 and the third guide ball GB3 on the third groove GR3. Accordingly, the AF carrier 10 in the second direction D2 may move through the housing H. For example, as both the first grooves GR1 and the third grooves GR3 extend in the second direction D2, the AF carrier 10 may move in the same second direction D2 as the direction in which the first grooves GR1 and the third grooves GR3 extend.

As the AF carrier 10 move in the second direction D2, the middle guide 40 combined with and connected to the AF carrier 10 and the lens carrier 20 combined with and connected to the middle guide 40 may also move in the second direction D2.

In this case, the lens carrier 20 may additionally move in the second direction D2 due to the fourth grooves GR4 extending in the second direction D2 on an upper surface of the middle guide 40, in addition to the movement in the second direction D2 due to the AF carrier 10.

In the case of the camera module according to related example, the coil may be disposed on a frame having a bending region. However, in a frame manufacturing process, when a curvature of the bending region is not constant, dispersion of the lens may be decreased when power was turned off. In addition, to form a bending region having a constant curvature, the number of components and manufacturing cost may be increased while process difficulty may be increased.

On the other hand, the camera module according to one or more embodiments and the camera module assembly including the same may include the housing and the coupling frame fixed to the housing. In this case, the coupling frame may have three surfaces on which the coil is disposed without a bending region, and the angle formed by the surfaces may be vertical. For example, as the coupling frame without a banding region is provided, dispersion of the lens may be improved even when power is off, and the process difficulty and manufacturing cost of the camera module may be reduced.

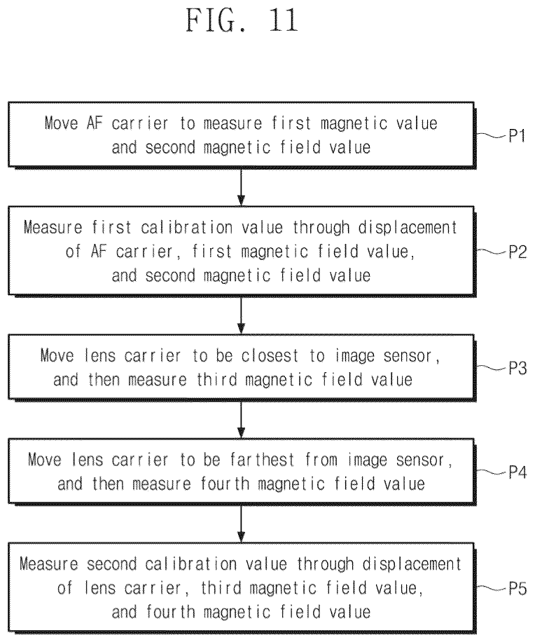

FIG. 11 is a flowchart for measuring a calibration value of a camera module according to one or more embodiments. For example, referring again to FIGS. 2 to 10C, the lens carrier 20 including the third magnet MG3 may additionally move in the second direction D2 due to the middle guide 40, in addition to the movement in the second direction D2 due to the AF carrier 10. In this case, a magnetic field value of the third magnet MG3 measured by the hall sensor HS located in the third coil C3 should consider both a displacement of the AF carrier 10 and a displacement of the lens carrier 20.

Hereinafter, a method for measuring the magnetic field value of the third magnet MG3 will be described by considering only the displacement of the lens carrier 20 moving to the middle guide 40 excluding the movement due to the AF carrier 10 in FIG. 11.

Referring to FIGS. 2 to 11, the AF carrier 10 may move to measure a first magnetic field value and a second magnetic field value in step P1. Moving the AF carrier 10 may include moving the AF carrier 10 in the second direction D2 toward or from the image sensor IMS. In this case, when the AF carrier 10 is positioned closest to the image sensor IMS, the first magnetic field value may be measured by the hall sensor HS located in the third coil C3. When the AF carrier 10 is positioned farthest from the image sensor IMS, the second magnetic field value may be measured by the hall sensor HS located in the third coil C3. The first magnetic field value and the second magnetic field value may correspond to either the maximum magnetic field value or the minimum magnetic field value measured through the movement of the AF carrier 10 depending on an arrangement of an N pole and an S pole included in the third magnet MG3.

A first calibration value may be measured through the displacement of the AF carrier 10, the first magnetic field value, and the second magnetic field value in step P2. The first calibration value may refer to a data value of the change in the displacement of the AF carrier 10 depending on change in the magnetic field value obtained through the hall sensor HS located in the third coil C3.

Thereafter, the lens carrier 20 may move to be closest to the image sensor IMS, and then a third magnetic field value may be measured in step P3. Moving the lens carrier 20 may include moving the AF carrier 10 in the second direction D2 to be closest to the image sensor IMS, and then moving the lens carrier 20 in the second direction D2 to be closest to the image sensor IMS through the middle guide 40.

The lens carrier 20 may move farthest from the image sensor IMS, and then a fourth magnetic field value may be measured in step P4. Moving the lens carrier 20 may include moving the AF carrier 10 in the second direction D2 to be closest to the image sensor IMS, and then moving the lens carrier 20 in the second direction D2 to be closest to the image sensor IMS through the middle guide 40.

The third magnetic field value and the fourth magnetic field value may correspond to either the maximum magnetic field value or the minimum magnetic field value measured through the movement of the lens carrier 20 depending on the arrangement of the N pole and S pole included in the third magnet MG3.

Thereafter, a second calibration value may be measured through a displacement of the lens carrier 20, the third magnetic field value, and the fourth magnetic field value in step P5. The second calibration value may refer to a data value of change in the displacement of the lens carrier 20 depending on change in the magnetic field value obtained through the hall sensor HS located in the third coil C3.

As the first and second calibration values are measured, the movement of the lens carrier 20 may be controlled regardless of the movement of the AF carrier 10, and crosstalk between the first magnet MG1 of the AF carrier 10 and the third magnet MG3 of the lens carrier 20 may be reduced or prevented.

The camera module according to one or more embodiments and the camera module assembly including the same may include the housing and the coupling frame fixed thereto. In this case, the coupling frame may have three surfaces on which the coils are disposed without a bending region, and the angle formed by the surfaces may be 90 degrees. For example, as the coupling frame without the bending region is provided, the dispersion of the lens may be improved even when the power is off, and the process difficulty and the manufacturing cost of the camera module may be reduced.

While embodiments have been described with reference to the figures, it will be understood by those of ordinary skill in the art that various changes in form and details may be made therein without departing from the spirit and scope as defined by the following claims and their equivalents.

What is claimed is:

1. A camera module comprising:
a housing; and
a coupling frame on the housing,
wherein the housing comprises:
a first main surface; and
a first side surface and a second side surface connected to the first main surface and spaced apart in a first direction, and
wherein the coupling frame comprises:
a second main surface;
a third side surface and a fourth side surface connected to the second main surface and spaced apart in the first direction;
a first coil on the second main surface;
a second coil on the third side surface; and
a third coil on the fourth side surface.

2. The camera module of claim 1, wherein the second main surface is on a first side of the first main surface,
wherein the third side surface is on the first side surface, and
wherein the fourth side surface is on the second side surface.

3. The camera module of claim 1, wherein the coupling frame further comprises a hall sensor included in the first coil, a hall sensor included in the second coil, and a hall sensor included in the third coil.

4. The camera module of claim 1, wherein, in the coupling frame, the second coil and the third coil face each other, and
wherein the first coil is between the second coil and the third coil.

5. The camera module of claim 1, wherein the housing further comprises a fifth side surface connecting the first side surface and the second side surface.

6. The camera module of claim 1, further comprising:
an autofocus (AF) carrier on the first main surface;
a lens carrier on the AF carrier; and
a telephoto lens on the lens carrier.

7. The camera module of claim 6, wherein the AF carrier comprises a first magnet on a first surface of the AF carrier, and
wherein the lens carrier comprises:
a second magnet on a first side surface of the lens carrier; and
a third magnet on a second side surface of the lens carrier opposite to the first side surface of the lens carrier.

8. The camera module of claim 7, wherein the second magnet and the third magnet are spaced apart in the first direction.

9. The camera module of claim 7, wherein the first magnet comprises a plurality of first magnets and the third magnet comprises a plurality of third magnets.

10. A camera module comprising:
a housing;
an autofocus (AF) carrier configured to move in a first direction in the housing;
a lens carrier configured to move in the first direction and a second direction perpendicular to the first direction on the AF carrier; and
a coupling frame on the housing,
wherein the AF carrier comprises a first magnet on a first surface of the AF carrier,
wherein the lens carrier comprises:
a second magnet on a first side surface of the lens carrier; and
a third magnet on a second side surface of the lens carrier opposite to the first side surface of the lens carrier,
wherein the coupling frame comprises a first coil, a second coil, and a third coil spaced apart from each other,
wherein the first magnet overlaps the first coil in a third direction perpendicular to the first direction and the second direction,
wherein the second magnet faces the second coil, and
wherein the third magnet faces the third coil.

11. The camera module of claim 10, wherein the housing further comprises a first groove on a first surface of the housing and a first guide ball on the first groove,
wherein the AF carrier further comprises a second groove on a first surface of the AF carrier and a second guide ball on the second groove, and
wherein the first groove and the second groove extend in the first direction.

12. The camera module of claim 10, wherein the AF carrier further comprises a third groove on a second surface of the AF carrier and a third guide ball on the third groove, and
wherein the third groove extends in the second direction.

13. The camera module of claim 10, further comprising:
a middle guide between the AF carrier and the lens carrier;
a reflective holder on the AF carrier; and
a reflective member on the reflective holder,
wherein the lens carrier is on the middle guide.

14. The camera module of claim 13, wherein the middle guide further comprises a fourth groove on a first surface of the middle guide and a fourth guide ball on the fourth groove, and
wherein the fourth groove extends in the first direction.

15. A camera assembly module comprising:
a housing;
an autofocus (AF) carrier on a first surface of the housing;
a lens carrier on the AF carrier;
a telephoto lens on the lens carrier;
a middle guide between the AF carrier and the lens carrier;
a coupling frame and a connection substrate on the housing; and
an image sensor on the connection substrate,
wherein the housing comprises:
a first main surface; and
a first side surface, a second side surface, and a third side surface connected to the first main surface,
wherein the coupling frame comprises:
a second main surface;
a fourth side surface and a fifth side surface connected to the second main surface, the fourth side surface and the fifth side surface being spaced apart in a first direction;
a first coil on the second main surface;
a second coil on the fourth side surface; and
a third coil on the fifth side surface,
wherein an angle formed by the second main surface and the fourth side surface and an angle formed by the second main surface and the fifth side surface are 90 degrees, and
wherein the middle guide is configured to move the lens carrier in a second direction perpendicular to the first direction.

16. The camera assembly module of claim 15, wherein the housing further comprises a guide ball,
wherein the guide ball is configured to move the AF carrier in the second direction, and
wherein the AF carrier is configured to move the middle guide in the first direction.

17. The camera assembly module of claim 15, wherein the image sensor is a charge coupled device (CCD) or a complementary metal-oxide-semiconductor (CMOS) image sensor (CIS).

18. The camera assembly module of claim 15, wherein the first side surface and the second side surface of the housing are spaced apart in the first direction,
wherein the third side surface connects the first side surface and the second side surface, and
wherein the first main surface, the first side surface, and the second side surface comprise a first opening, a second opening, and a third opening, respectively.

19. The camera assembly module of claim 18, wherein the first coil is in the first opening,
wherein the second coil is in the second opening, and
wherein the third coil is in the third opening.

20. The camera assembly module of claim 15, wherein the second main surface, the fourth side surface, and the fifth side surface of the coupling frame are on an outside surface of the housing.
